(19) United States
(12) Patent Application Publication
(10) Pub. No.: US 2025/0156100 A1
(43) Pub. Date: May 15, 2025

(54) FINE-GRAINED DATA MOVER

(71) Applicant: Micron Technology, Inc., Boise, ID (US)

(72) Inventors: Craig William Warner, Coppell, TX (US); Tony M. Brewer, Plano, TX (US); Jason Douglas Jung, Allen, TX (US)

(21) Appl. No.: 18/777,076

(22) Filed: Jul. 18, 2024

Related U.S. Application Data
(60) Provisional application No. 63/548,125, filed on Nov. 10, 2023.

(51) Int. Cl. G06F 3/06

(52) U.S. Cl. CPC G06F 3/0647; G06F 3/0604; G06F 3/0679

(57) ABSTRACT

Disclosed in some examples are improvements to memory controllers on distributed memory systems that include a fine-grained data mover component that offloads management of memory commands accessing multiple smaller values to the memory controller. The fine-grained data mover (FGDM) may provide low host processing overhead that enables performance improvements for small task offloads. Work requests (“data mover calls”) may be sent by hosts to the FGDM without OS system calls. The FGDM is a virtually addressed data movement engine architected to transfer data at high transfer rates even during situations where the host has many small data movement requests and where the source and/or destination addresses are not memory controller friendly.

### PRIORITY APPLICATION

This application claims the benefit of priority to U.S. Provisional Application Ser. No. 63/548,125, filed Nov. 10, 2023, which is incorporated herein by reference in its entirety.

### GOVERNMENT RIGHTS

This invention was made with United States Government support under Contract Number DE-NA0003525; subcontract 2168213 with Sandia National Laboratories of the United States Department of Energy. The United States Government has certain rights in this invention.

### TECHNICAL FIELD

Embodiments pertain to improving the efficiency of distributed memory systems.

### BACKGROUND

Memory devices for computers or other electronic devices may be categorized as volatile and non-volatile memory. Volatile memory requires power to maintain its data, and includes random-access memory (RAM), dynamic random-access memory (DRAM), or synchronous dynamic random-access memory (SDRAM), among others. Non-volatile memory can retain stored data when not powered, and includes flash memory, read-only memory (ROM), electrically erasable programmable ROM (EEPROM), static RAM (SRAM), erasable programmable ROM (EPROM), resistance variable memory, phase-change memory, storage class memory, resistive random-access memory (RRAM), and magnetoresistive random-access memory (MRAM), among others. Persistent memory is an architectural property of the system where the data stored in the media is available after system reset or power-cycling. In some examples, non-volatile memory media may be used to build a system with a persistent memory model.

Memory devices may be coupled to a host (e.g., a host computing device) to store data, commands, and/or instructions for use by the host while the computer or electronic system is operating. For example, data, commands, and/or instructions can be transferred between the host and the memory device(s) during operation of a computing or other electronic system.

Various protocols or standards can be applied to facilitate communication between a host and one or more other devices such as memory buffers, accelerators, or other input/output devices. In an example, a protocol such as Compute Express Link (CXL) can be used to provide high-bandwidth and low-latency connectivity.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1A is a representation of a chiplet system mounted on a peripheral board according to some examples of the present disclosure.

FIG. 1B is a block diagram labeling the components in the chiplet system according to some examples of the present disclosure.

FIG. 2 illustrates a distributed memory system according to some examples of the present disclosure.

FIG. 3 illustrates a block diagram of how the data mover component interfaces with other components of the memory controller according to some examples of the present disclosure.

FIG. 4 illustrates a block diagram of a fine-grained data mover according to some examples of the present disclosure.

FIG. 5 illustrates a block diagram of a FGDM according to some examples of the present disclosure.

FIG. 6A illustrates the phases of a data mover task (DMT) that are launched from copy, scatter-stride, or gather-stride calls according to some examples of the present disclosure.

FIG. 6B illustrates the phases Data Mover Tasks generated from scatter-address, scatter-index, gather-address, and gather-index calls according to some examples of the present disclosure.

FIG. 7 illustrates a flowchart of a method of processing a call in a fine-grained data mover according to some examples of the present disclosure.

FIG. 8 is a block diagram illustrating an example of a machine upon which one or more embodiments may be implemented.

### DETAILED DESCRIPTION

Compute Express Link (CXL) is an open standard interconnect configured for high-bandwidth, low-latency connectivity between host devices and other devices such as accelerators, memory devices, and smart I/O devices. CXL was designed to facilitate high-performance computational workloads by supporting heterogeneous processing and memory systems. CXL enables coherency and memory semantics on top of PCI Express (PCIe)-based I/O semantics for optimized performance.

In some examples, CXL is used in applications such as artificial intelligence, machine learning, analytics, cloud infrastructure, edge computing devices, communication systems, and elsewhere. Data processing in such applications can use various scalar, vector, matrix and spatial architectures that can be deployed in CPU, GPU, FPGA, smart NICs, and other accelerators that can be coupled using a CXL link.

CXL supports dynamic multiplexing using a set of protocols that includes input/output (CXL.io, based on PCIe), caching (CXL.cache), and memory (CXL.memory) semantics. In an example, CXL can be used to maintain a unified, coherent memory space between the CPU (e.g., a host device or host processor) and any memory on an attached CXL device. This configuration allows the CPU and other devices to share resources and operate on the same memory region for higher performance, reduced data-movement, and reduced software stack complexity. In an example, the CPU is primarily responsible for maintaining or managing coherency in a CXL environment. Accordingly, CXL can be leveraged to help reduce device cost and complexity, as well as overhead traditionally associated with coherency across an I/O link.

CXL runs on PCIe PHY and provides full interoperability with PCIe. In an example, a CXL device starts link training in a PCIe Gen 1 Data Rate and negotiates CXL as its operating protocol (e.g., using the alternate protocol negotiation mechanism defined in the PCIe 5.0 specification) if its link partner is capable of supporting CXL. Devices and platforms can thus more readily adopt CXL by leveraging the PCIe infrastructure and without having to design and validate the PHY, channel, channel extension devices, or other upper layers of PCIe.

In an example, CXL supports single level switching to enable fan-out to multiple devices. This enables multiple devices in a platform to migrate to CXL, while maintaining backward compatibility and the low-latency characteristics of CXL. In an example, CXL can provide a standardized compute fabric that supports pooling of multiple logical devices (MLD) and single logical devices such as using a CXL switch connected to several host devices or nodes (e.g., Root Ports). This feature enables servers to pool resources such as accelerators and/or memory that can be assigned according to workload. For example, CXL can help facilitate resource allocation or dedication and release. In an example, CXL can help allocate and deallocate memory to various host devices according to need. This flexibility helps designers avoid over-provisioning while ensuring best performance. The CXL protocol enables the construction of large, multi-host, fabric attached memory system. Furthermore, CXL memory systems can be built out of multi-ported, hot swappable device and connected with hot swappable memory switches.

Some of the compute-intensive applications and operations mentioned herein can require or use large data sets. Memory devices that store such data sets can be configured for low latency and high bandwidth and persistence. One problem of a load-store interconnect architecture includes guaranteeing persistence. CXL can help address the problem using an architected flow and standard memory management interface for software, such as can enable movement of persistent memory from a controller-based approach to direct memory management.

In some examples, such distributed memory systems may be built using chiplets. Chiplets are an emerging technique for integrating various processing functionalities. Generally, a chiplet system is made up of discrete modules (each a “chiplet”) that are integrated on an interposer, and in many examples interconnected as desired through one or more established networks, to provide a system with the desired functionality. The interposer and included chiplets may be packaged together to facilitate interconnection with other components of a larger system. Each chiplet may include one or more individual integrated circuits, or “chips” (ICs), potentially in combination with discrete circuit components, and commonly coupled to a respective substrate to facilitate attachment to the interposer. Most or all chiplets in a system will be individually configured for communication through the one or more established networks.

The configuration of chiplets as individual modules of a system is distinct from such a system being implemented on single chips that contain distinct device blocks (e.g., intellectual property (IP) blocks) on one substrate (e.g., single die), such as a system-on-a-chip (SoC), or multiple discrete packaged devices integrated on a printed circuit board (PCB). In general, chiplets provide better performance (e.g., lower power consumption, reduced latency, etc.) than discrete packaged devices, and chiplets provide greater production benefits than single die chips. These production benefits can include higher yields or reduced development costs and time.

Chiplet systems may include, for example, one or more application (or processor) chiplets and one or more support chiplets. Here, the distinction between application and support chiplets is simply a reference to the likely design scenarios for the chiplet system. Thus, for example, a synthetic vision chiplet system can include, by way of example only, an application chiplet to produce the synthetic vision output along with support chiplets, such as a memory controller chiplet, a sensor interface chiplet, or a communication chiplet. In a typical use case, the synthetic vision designer can design the application chiplet and source the support chiplets from other parties. Thus, the design expenditure (e.g., in terms of time or complexity) is reduced because by avoiding the design and production of functionality embodied in the support chiplets. Chiplets also support the tight integration of IP blocks that can otherwise be difficult, such as those manufactured using different processing technologies or using different feature sizes (or utilizing different contact technologies or spacings). Thus, multiple IC's or IC assemblies, with different physical, electrical, or communication characteristics may be assembled in a modular manner to provide an assembly providing desired functionalities. Chiplet systems can also facilitate adaptation to suit needs of different larger systems into which the chiplet system will be incorporated. In an example, integrated circuits or other assemblies can be optimized for the power, speed, or heat generation for a specific function—as can happen with sensors—and can be integrated with other devices more easily than attempting to do so on a single die. Additionally, by reducing the overall size of the die, the yield for chiplets tends to be higher than that of more complex, single die devices.

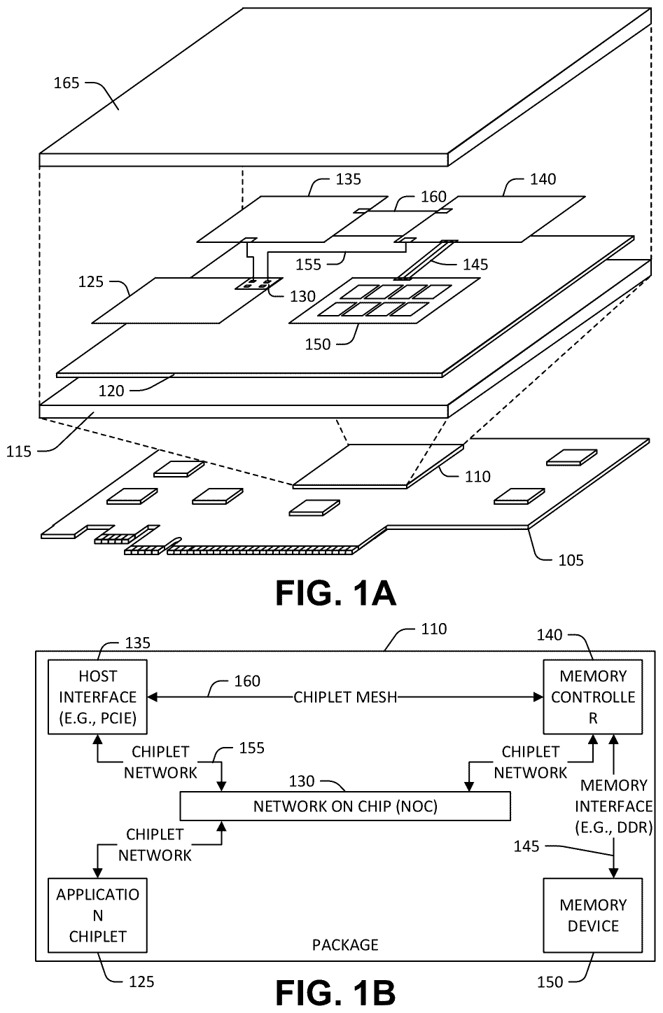

FIGS. 1A and 1B illustrate an example of a chiplet system 110, according to an embodiment. FIG. 1A is a representation of the chiplet system 110 mounted on a peripheral board 105, that can be connected to a broader computer system by a peripheral component interconnect express (PCIe), for example. The chiplet system 110 includes a package substrate 115, an interposer 120, and four chiplets, an application chiplet 125, a host interface chiplet 135, a memory controller chiplet 140, and a memory device chiplet 150. Other systems may include many additional chiplets to provide additional functionalities as will be apparent from the following discussion. The package of the chiplet system 110 is illustrated with a lid or cover 165, though other packaging techniques and structures for the chiplet system can be used. FIG. 1B is a block diagram labeling the components in the chiplet system for clarity.

The application chiplet 125 is illustrated as including a network-on-chip (NOC) 130 to support a chiplet network 155 for inter-chiplet communications. In example embodiments NOC 130 may be included on the application chiplet 125. In an example, NOC 130 may be defined in response to selected support chiplets (e.g., chiplets 135, 140, and 150) thus enabling a designer to select an appropriate number or chiplet network connections or switches for the NOC 130. In an example, the NOC 130 can be located on a separate chiplet, or even within the interposer 120. In examples as discussed herein, the NOC 130 implements a chiplet protocol interface (CPI) network.

The CPI is a packet-based network that supports virtual channels to enable a flexible and high-speed interaction between chiplets. CPI enables bridging from intra-chiplet networks to the chiplet network 155. For example, the Advanced eXtensible Interface (AXI) is a widely used specification to design intra-chip communications. AXI specifications, however, cover a great variety of physical design options, such as the number of physical channels, signal timing, power, etc. Within a single chip, these options are generally selected to meet design goals, such as power consumption, speed, etc. However, to achieve the flexibility of the chiplet system, an adapter, such as CPI, is used to interface between the various AXI design options that can be implemented in the various chiplets. By enabling a physical channel to virtual channel mapping and encapsulating time-based signaling with a packetized protocol, CPI bridges intra-chiplet networks across the chiplet network 155.

CPI can use a variety of different physical layers to transmit packets. The physical layer can include simple conductive connections, or can include drivers to increase the voltage, or otherwise facilitate transmitting the signals over longer distances. An example of one such physical layer can include the Advanced Interface Bus (AIB), which in various examples, can be implemented in the interposer 120. AIB transmits and receives data using source synchronous data transfers with a forwarded clock. Packets are transferred across the AIB at single data rate (SDR) or dual data rate (DDR) with respect to the transmitted clock. Various channel widths are supported by AIB. AIB channel widths are in multiples of 20 bits when operated in SDR mode (20, 40, 60, . . . ), and multiples of 40 bits for DDR mode: (40, 80, 120, . . . ). The AIB channel width includes both transmit and receive signals. The channel can be configured to have a symmetrical number of transmit (TX) and receive (RX) input/outputs (I/Os), or have a non-symmetrical number of transmitters and receivers (e.g., either all transmitters or all receivers). The channel can act as an AIB master or slave depending on which chiplet provides the master clock. AIB I/O cells support three clocking modes: asynchronous (i.e., non-clocked), SDR, and DDR. In various examples, the non-clocked mode is used for clocks and some control signals. The SDR mode can use dedicated SDR only I/O cells, or dual use SDR/DDR I/O cells.

In an example, CPI packet protocols (e.g., point-to-point or routable) can use symmetrical receive and transmit I/O cells within an AIB channel. The CPI streaming protocol allows more flexible use of the AIB I/O cells. In an example, an AIB channel for streaming mode can configure the I/O cells as all TX, all RX, or half RX and half RX. CPI packet protocols can use an AIB channel in either SDR or DDR operation modes. In an example, the AIB channel is configured in increments of 80 I/O cells (i.e., 40 TX and 40 RX) for SDR mode and 40 I/O cells for DDR mode. The CPI streaming protocol can use an AIB channel in either SDR or DDR operation modes. Here, in an example, the AIB channel is in increments of 40 I/O cells for both SDR and DDR modes. In an example, each AIB channel is assigned a unique interface identifier. The identifier is used during CPI reset and initialization to determine paired AIB channels across adjacent chiplets. In an example, the interface identifier is a 20-bit value comprising a seven-bit chiplet identifier, a seven-bit column identifier, and a six-bit link identifier. The AIB physical layer transmits the interface identifier using an AIB out-of-band shift register. The 20-bit interface identifier is transferred in both directions across an AIB interface using bits 32-51 of the shift registers.

AIB defines a stacked set of AIB channels as an AIB channel column. An AIB channel column has some number of AIB channels, plus an auxiliary channel. The auxiliary channel contains signals used for AIB initialization. All AIB channels (other than the auxiliary channel) within a column are of the same configuration (e.g., all TX, all RX, or half TX and half RX, as well as having the same number of data I/O signals). In an example, AIB channels are numbered in continuous increasing order starting with the AIB channel adjacent to the AUX channel. The AIB channel adjacent to the AUX is defined to be AIB channel zero.

Generally, CPI interfaces on individual chiplets can include serialization-deserialization (SERDES) hardware. SERDES interconnects work well for scenarios in which high-speed signaling with low signal count are desirable. SERDES, however, can result in additional power consumption and longer latencies for multiplexing and demultiplexing, error detection or correction (e.g., using block level cyclic redundancy checking (CRC)), link-level retry, or forward error correction. However, when low latency or energy consumption is a primary concern for ultra-short reach, chiplet-to-chiplet interconnects, a parallel interface with clock rates that allow data transfer with minimal latency may be utilized. CPI includes elements to minimize both latency and energy consumption in these ultra-short reach chiplet interconnects.

For flow control, CPI employs a credit-based technique. A recipient, such as the application chiplet 125, provides a sender, such as the memory controller chiplet 140, with credits that represent available buffers. In an example, a CPI recipient includes a buffer for each virtual channel for a given time-unit of transmission. Thus, if the CPI recipient supports five messages in time and a single virtual channel, the recipient has five buffers arranged in five rows (e.g., one row for each unit time). If four virtual channels are supported, then the recipient has twenty buffers arranged in five rows. Each buffer holds the payload of one CPI packet.

When the sender transmits to the recipient, the sender decrements the available credits based on the transmission. Once all credits for the recipient are consumed, the sender stops sending packets to the recipient. This ensures that the recipient always has an available buffer to store the transmission. As the recipient processes received packets and frees buffers, the recipient communicates the available buffer space back to the sender. This credit return can then be used by the sender to allow transmitting of additional information.

Also illustrated is a chiplet mesh network 160 that uses a direct, chiplet-to-chiplet technique without the need for the NOC 130. The chiplet mesh network 160 can be implemented in CPI, or another chiplet-to-chiplet protocol. The chiplet mesh network 160 generally enables a pipeline of chiplets where one chiplet serves as the interface to the pipeline while other chiplets in the pipeline interface only with themselves.

Additionally, dedicated device interfaces, such as one or more industry standard memory interfaces 145 (such as, for example, synchronous memory interfaces, such as DDR5, DDR 6), can also be used to interconnect chiplets. Connection of a chiplet system or individual chiplets to external devices (such as a larger system can be through a desired interface (for example, a PCIE interface). Such as external interface may be implemented, in an example, through a host interface chiplet 135, which in the depicted example, provides a PCIE interface external to chiplet system 110. Such dedicated interfaces 145 are generally employed when a convention or standard in the industry has converged on such an interface. The illustrated example of a Double Data Rate (DDR) interface 145 connecting the memory controller chiplet 140 to a dynamic random access memory (DRAM) memory device chiplet 150 is just such an industry convention.

Of the variety of possible support chiplets, the memory controller chiplet 140 is likely present in the chiplet system 110 due to the near omnipresent use of storage for computer processing as well as sophisticated state-of-the-art for memory devices. Thus, using memory device chiplets 150 and memory controller chiplets 140 produced by others gives chiplet system designers access to robust products by sophisticated producers. Generally, the memory controller chiplet 140 provides a memory device specific interface to read, write, or erase data. Often, the memory controller chiplet 140 can provide additional features, such as error detection, error correction, maintenance operations, or atomic operation execution. For some types of memory, maintenance operations tend to be specific to the memory device 150, such as garbage collection in NAND flash or storage class memories, temperature adjustments (e.g., cross temperature management) in NAND flash memories. In an example, the maintenance operations can include logical-to-physical (L2P) mapping or management to provide a level of indirection between the physical and logical representation of data. In other types of memory, for example DRAM, some memory operations, such as refresh may be controlled by a host processor or of a memory controller at some times, and at other times controlled by the DRAM memory device, or by logic associated with one or more DRAM devices, such as an interface chip (in an example, a buffer).

The memory device chiplet 150 can be, or include any combination of, volatile memory devices or non-volatile memories. Examples of volatile memory devices include, but are not limited to, random access memory (RAM)—such as DRAM) synchronous DRAM (SDRAM), graphics double data rate type 6 SDRAM (GDDR6 SDRAM), among others. Examples of non-volatile memory devices include, but are not limited to, negative-and-(NAND)-type flash memory, storage class memory (e.g., phase-change memory or memristor based technologies), ferroelectric RAM (FeRAM), among others. The illustrated example includes the memory device 150 as a chiplet, however, the memory device 150 can reside elsewhere, such as in a different package on the board 105. For many applications, multiple memory device chiplets may be provided. In an example, these memory device chiplets may each implement one or multiple storage technologies. In an example, a memory chiplet may include multiple stacked memory die of different technologies, for example one or more SRAM devices stacked or otherwise in communication with one or more DRAM devices. Memory controller chiplet 140 may also serve to coordinate operations between multiple memory chiplets in chiplet system 110; for example, to utilize one or more memory chiplets in one or more levels of cache storage, and to use one or more additional memory chiplets as main memory. Chiplet system 110 may also include multiple memory controller chiplets 140, as may be used to provide memory control functionality for separate processors, sensors, networks, etc. A chiplet architecture, such as chiplet system 110 offers advantages in allowing adaptation to different memory storage technologies; and different memory interfaces, through updated chiplet configurations, without requiring redesign of the remainder of the system structure. Memory controller chiplet 140 may include processing hardware, working memory, and the like that enable the memory controller chiplet 140 to perform operations on data. For example, a memory controller chiplet 140 may include fine-grained data mover logic that implements many of the techniques described herein.

Many high-performance computing applications may benefit from hardware architectures with more memory bandwidth, such as distributed memory architectures. Example applications include the Page Rank algorithm used by Google® for rating the importance of each web page on the internet; Sparse BLAS libraries like NIST Sparse-BLAS; Stencil; and others. These applications benefit from the construction of multi-host clusters with more memory bandwidth than what can be seen by the hosts.

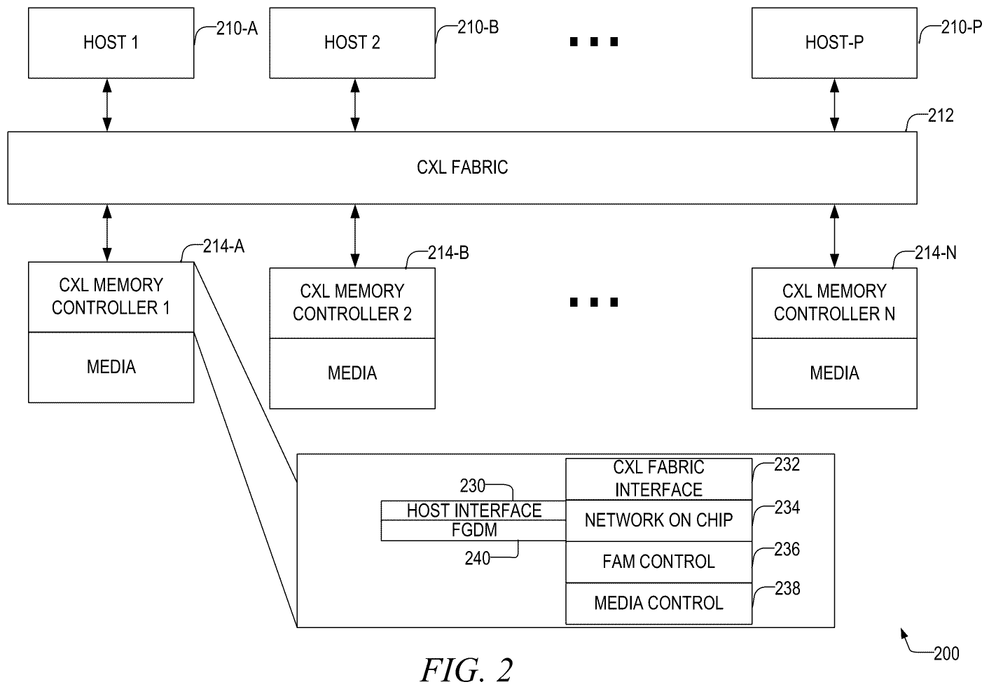

FIG. 2 illustrates a distributed memory system 200 according to some examples of the present disclosure. Hosts 210-A, 210-B . . . 210-P are connected using a memory fabric, such as a CXL fabric 212. The CXL fabric 212 is connected to a plurality of memory devices 214-A-214-N. The memory devices may include memory controllers and memory media. In some examples, N>P, such that the memory devices 214 outnumber the hosts. In some examples, the distributed memory system 200 may be or include a chiplet system such that one or more of the components shown may be chiplets. In some examples, some components may be chiplets and other components may be connected with other types of computing buses.

Hosts performing sparse operations, such as matrix operations, may issue a significant number of commands reading and writing smaller values for a single matrix operation. For example, the algorithm Stencil may perform thousands of memory commands, each command reading or writing less than 32, 64-bit floating point numbers. These commands may utilize fabric bandwidth as the host issues these thousands of commands over the CXL fabric 212 to the various memory controllers. In addition, these commands utilize processing overhead on the hosts that need to track and manage these commands.

Disclosed in some examples are improvements to memory controllers on distributed memory systems that include a fine-grained data mover (FGDM) component that offloads management of memory commands accessing multiple smaller values to the memory controller. By providing data mover calls that offload a portion of the work of accessing multiple smaller values to the FGDM, CXL fabric bandwidth may be freed up, and host processing overhead may be reduced to enable performance improvements. Work requests in the form of data mover calls or commands may be sent by hosts to the FGDM without utilizing OS system calls. The FGDM is a virtually addressed data movement engine architected to transfer data at high transfer rates. Data mover calls are commands sent from a host or other processor to the memory controller commanding a unit of the memory controller (the FGDM) to perform a specified operation.

The FGDM converts Data Mover Calls into one or more transfer groups known as a Data Mover Task and assigns these tasks to data movement engines, such as AMBA-AXI4 slice data movement engines. Each Data Mover Task is responsible for transferring a small amount of data and the AXI slice is designed to actively work on multiple data mover tasks concurrently. Because multiple data mover tasks from multiple data mover calls can be actively worked on at the same time, the FGDM can maintain a high-level of utilization even if each data mover call is small.

The data mover task concept allows the hardware to be scheduled at a small granularity, which is useful when trying to achieve high performance with many small requests or enforcing per-tenant QoS policies when multiple tenants are using a single data mover. In some examples, a Data Mover Task manages the movement of up to 256 bytes or up to 16 elements—whichever limit is hit first when the FGDM hardware breaks the data mover call into data mover tasks. A data mover task has at least a read and a write phase and may include an optional fetch phase for acquiring addresses.

In FIG. 2, the memory controllers, such as memory controller 1 214-A may include a fine-grained data mover (FGDM) component 240 on a network-on-chip architecture. The memory controllers, such as memory controller 1 214-A, may also include a host interface component 230, a CXL fabric interface component 232, a network on-chip interface component 234, a FAM control component 236, and a media control component 238. The various components may be implemented as hardware, hardware configured by software, or the like. The host interface component 230 may implement one or more protocols or interfaces with the host to receive memory commands including data mover calls. The FGDM component 240 may include one or more processors, memory, or the like to implement the data mover calls as described herein. The CXL fabric interface component 232 may implement one or more protocols or interfaces to communicate over the CXL fabric 212. The network-on-chip interface component 234 may implement one or more network-on-chip interfaces as described previously. The media control component 238 may implement media control operations such as implementing read and write scheduling, refresh control, and ECC. For example, the media control component 238 may be a DRAM controller. In some examples, the FAM control component 236 includes address translation tables and access control tables to translate addresses between various forms to route memory requests to the proper devices and back.

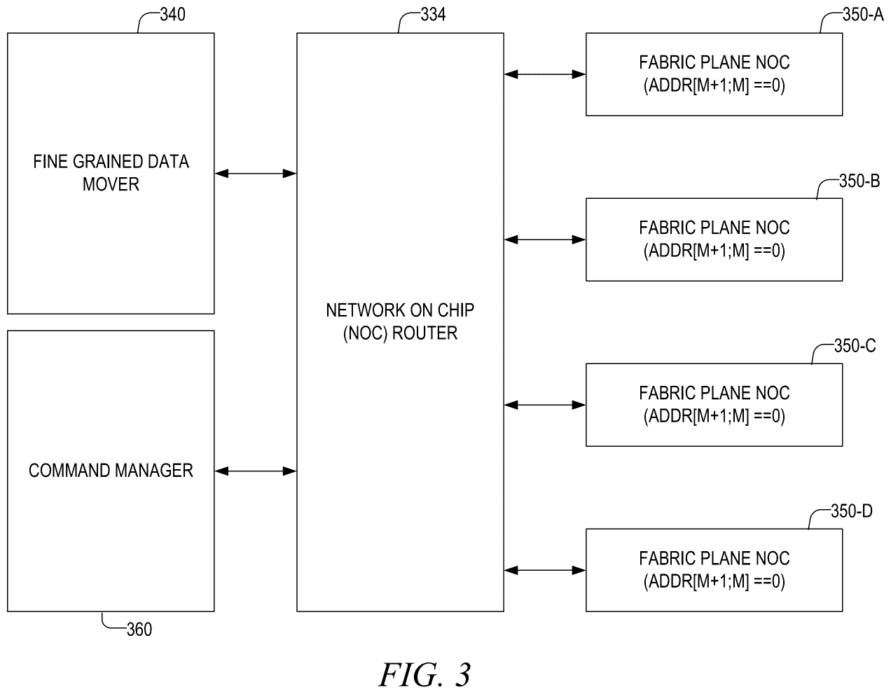

FIG. 3 illustrates a block diagram of how the data mover component interfaces with other components of the memory controller according to some examples of the present disclosure. The network on-chip router 334 routes requests being initiated by the fine-grained data mover component 340 to the correct address interleaved fabric plane 350-A, 350-B, 350-C, or 350-D. A host system (or other processors) utilize the command manager 360 to issue Data Mover Calls to the Data Mover.

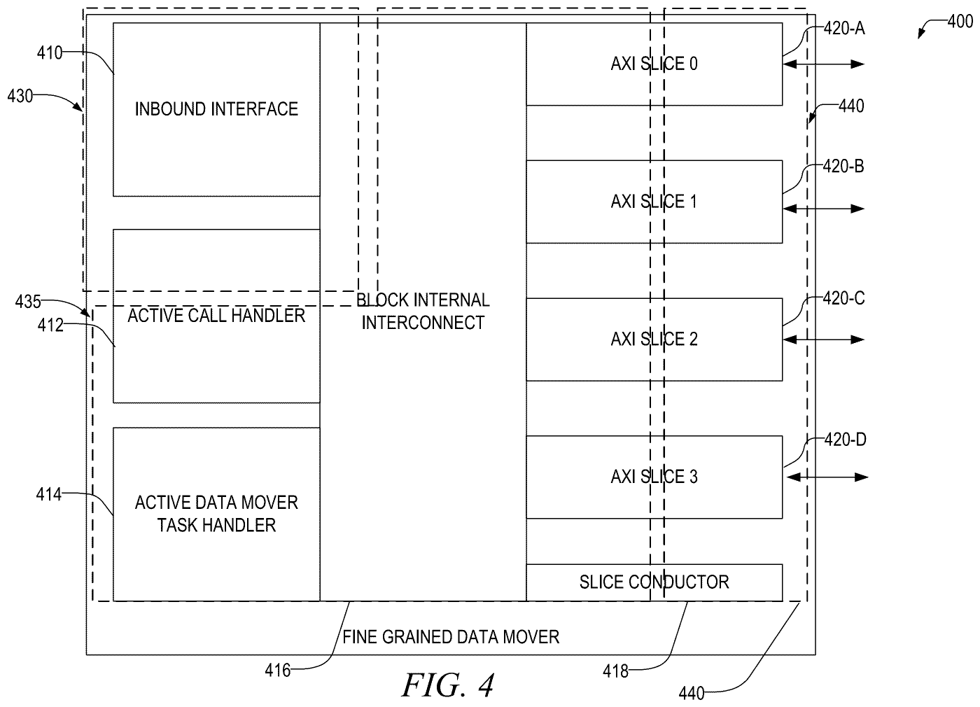

FIG. 4 illustrates a block diagram of a fine-grained data mover component 400 according to some examples of the present disclosure. FGDM component 400 may be an example of FGDM component 240, 340. Inbound interface 410 receives new call requests as well as configuration status register (CSR) read and write requests. The active call handler component 412 breaks calls down into data mover tasks; tracks completion of concurrently active calls; and formulates call returns for calls. Each data mover task has a read and a write phase, and some data mover tasks (depending on the data mover call) may have a fetch phase (e.g., to fetch a list of addresses). The tasks can include:

| DM Task | Description | Phases |
|---|---|---|
| AtoB | Read from one contiguous | Optional Fetch Phase, Read, |
| | region and write data into 1 to | Write |
| | many regions | |
| BtoA | Read from 1 to many regions | Optional Fetch Phase, Read, |
| | and write the data into one | and Write phase |
| | contiguous region | |
| Set | Write into 1 to many regions; | Optional Fetch Phase, Read, |
| | Data comes from the FGDM | and Write Phases. The read |
| | call | phase sends the addresses and |
| | | command information to the |
| | | slice, but no actual AXI reads |
| | | are issued. |

Tasks may be broken down based upon a mapping between data mover calls and data mover tasks. For example, according to the following table:

| CALL | DM TASKS |
|---|---|
| Copy | AtoB, NumOps = 1 |
| Gather | BtoA, NumOps = 1 to Many |
| Scatter | AtoB, NumOps = 1 to Many |
| Set | Set, NumOps = 1 to Many |

In some examples, there may be different strategies used to launch a particular data mover task depending on the call length and element size being operated upon. For example:

| Call Criteria | Element Size | | Launching Strategy |
|---|---|---|---|
| ((Call:length <=256 Bytes) | N/A | | SmallCall |
| && (Call:numElements <=16)) | | | |
| Calls not meeting the above | <=256 | Bytes | BigCallSmallElement |
| criteria | | | |
| Calls not meeting the above | >256 | Bytes | BigCallBigElement |
| criteria | | | |

Based upon the launching strategy, the allocation and launching priorities may be adjusted. For example:

| | Launching | | |
|---|---|---|---|
| Launching Strategy | Rate | Slice Interleave | Allocation Policy |
| SmallCall | 1 DMTask | Use only one | All work assigned |
| | per clock | AXI slice in | to one DMTask |
| | | DmTask Group; | |
| | | Use Current | |
| | | Slice | |
| BigCallSmallElement | 1 DMTask | Starts at Current | 1 to 16 elements |
| | per clock | Slice in each | per DMTask; |
| | | Data Mover | Total Bytes |
| | | Task Group | is <256 B; No |
| | | | Partial element |
| | | | handling |
| BigCallBigElement | 1 DMTask | Starts at Current | 1 element; |
| | per clock | Slice in each | 1-256 B per |
| | | Data Mover | DMTask; Partial |
| | | Task Group | Element Handling |

In some examples, the Call Handler logic which launches Data Mover Tasks, has a Current Slice indication. This Current Slice is incremented at the end of every Call.

| Launching Strategy | Division Implementation |
|---|---|
| SmallCall | None |
| BigCallSmallElement | 256/Element Length; Implementation idea: Use |
| | a generic division (~8 clock division) if |
| | element size is not equal to 1, 2, 4, 8, 16, |
| | 32, 64, or 128 B. |
| BigCallBigElement | Length reduced by 256B or remainder of element |
| | every clock |

| Launching Strategy | DM Element Size |
|---|---|
| SmallCall | Equals Call Element Size |
| BigCallSmallElement | Equals Call Element Size |
| BigCallBigElement | First DMTask might be less than 0 × 100 |
| | because of alignment optimization |
| | Body of the element will be set to 0 × 100 |
| | Last for the element may be less than 0 × 100 |

The active data mover task handler component 414 schedules read and writes to be performed by each of the AXI slices 420-A; 420-B; 420-C; and 420-D. For example, based upon the above strategies. While four AXI slices are shown, other numbers of AXI slices may be utilized. The AXI slices 420-A; 420-B; 420-C; and 420-D break data mover tasks down into AXI read and write operations. Each AXI slice may stay focused on one phase of a data mover task before moving onto a different phase of a different data mover task. In some examples, an AXI slice may be generating read commands for one task while generating write commands for another task. Tasks in the read phase are scheduled by the AXI slice's task handler to its read generation block. At the same time, there may be a pool of tasks in the write phase being scheduled for the slice's write generation. The slice conductor component 418 coordinates reading and writing between the AXI slices to optimize memory usage. The block internal interconnect 416 may include one or more hardware or software structures to connect the inbound interface 410, active call handler component 412, and active data mover task handler component 414 to one or more AXI slices, such as AXI slices 420-A, 420-B, 420-C, and 420-D. In some examples, each AXI slice may support multiple outstanding read and write requests where a read request may be given a read identifier.

As noted, the fine-grained data mover receives call requests and breaks the call down into data mover tasks. Each data mover task has phases. These data mover tasks are then further broken down into AXI Read and AXI Write Requests. While AMBA-AXI fabrics are used herein, a person of ordinary skill in the art will recognize that fabrics other than AMBA-AXI may be utilized. FIG. 4 illustrates, using dashed line boxes, the unit of work that the components operate upon. The call domain 430 comprises the inbound interface 410, block internal interconnect component 416, and the active call handler component 412. These components deal with FGDM calls. The data mover task domain 435 comprises the active call handler component 412, the active data mover task handler component 414, the block internal interconnect component 416, AXI slices, and slice conductor component 418. The AXI memory request domain 440 includes the AXI slices and the slice conductor component 418.

As noted previously, calls may be a basic data movement operation such as: copy, scatter, gather, or set. Copy operations move an integer number of bytes from one byte aligned virtual address to another byte aligned virtual address. In some examples, if the source and destination buffer overlap then the state of main memory after the operation is done may not be defined. Scatter operations move data in a contiguously addressed buffer to an integer number of destination element locations. In some examples, all elements in the scatter call may be restricted to being the same size. Scatter calls may use one of three different addressing modes—strided, addressed, or indexed. Gather operations move data from an integer number of source element locations into a contiguously addressed destination buffer. In some examples, all the elements in the gather call may be restricted such that they are a same size. Gather operations use the same three different addressing modes as scatter calls—strided, addressed, or indexed. Set operations write a predefined size (e.g., 64B) of data pattern into an integer number of destination element locations. In some examples, all the elements in the gather call may be restricted to the same size. Gather operations use the same three different addressing modes as scatter calls—strided, addressed, or indexed.

The FGDM supports a generic call/return interface that allows requesters to build call requests and to receive return responses when the FGDM operation has completed. FGDM operations can be invoked on behalf of a user host process or by the host operating system. In some examples, the FGDM may support multiple simultaneous transfers due to the latencies of translation look aside buffer (TLB) miss and fault handling. To accomplish this a means of maintaining the state of multiple transfer contexts may be provided.

The scatter and gather commands support three modes in which a non-contiguous memory region can be defined. A strided mode specifies a base virtual address, a uniform stride size, an element size, and a number of elements in the call command. The number of addresses used is specified by the number of elements and the addresses start at the base virtual address and increment an amount specified by the stride size. The next mode, an addressed mode, specifies a memory address with a list of virtual addresses. The call utilizing the addressed mode includes an address list base virtual address, an element size, and a number of elements. The memory addresses are read from the address list in memory at the address list base virtual address. The offset mode utilizes an offset list that is similar to the address list in that the call contains a memory location in which the addresses are stored. In the offset list, the call specifies a base virtual address, a virtual address for the offset list, an element size, and a number of elements.

The data mover calls may specify addresses for both the source and destination memory regions. A subset of the data mover functionality, which may be only available to an Operating System, can also be used to enable block configuration status register (CSR) access operations. These operations would use virtual addresses for one memory region (source or destination) and physical addresses for the CSRs. The physical addresses for the CSRs could be directly specified or they could be generated by the memory management unit (MMU) in the normal translation process. One type of block CSR operation could be a Scatter command where values can be written to a set of CSRs in a strided access. Similarly, CSR gather operations could read a set of CSRs using a strided access and write those to a contiguous destination memory region.

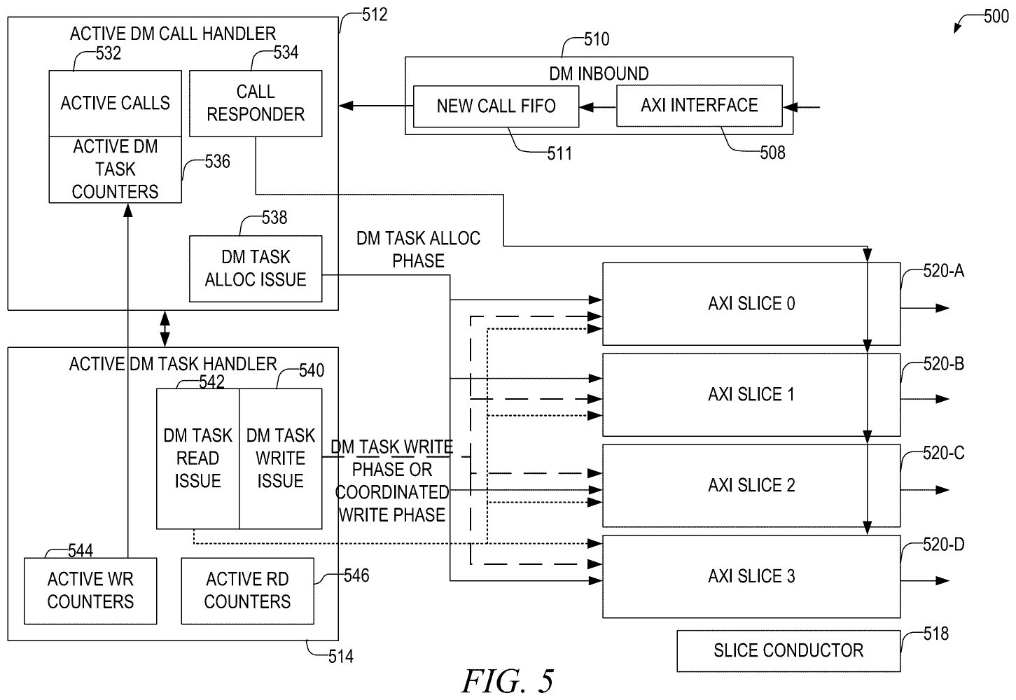

FIG. 5 illustrates a block diagram of a FGDM 500 according to some examples of the present disclosure. The FGDM 500 may be an example of FGDM component 400, 340, and/or 240 according to some examples. The FGDM 500 includes a data mover (DM) inbound interface component 510 that processes inbound calls received from one or more host systems over an AXI interface component 508. The DM inbound interface component 510 queues the new calls into a FIFO queue 511. The calls are then released in a FIFO order to the active DM call handler 512.

The active calls component 532 of the DM call handler 512 splits DM calls into data mover tasks and the DM task allocation issue component 538 allocates the first phase, e.g., the fetch or the read phase for each of these tasks to an AXI slice 520-A; 520-B; 520-C; 520-D. Call responder component 534 may determine when data mover calls are complete, and schedules AXI writes to return the results of the data mover calls. The DM considers a call complete when all of the write phases for all of the call's DM tasks are complete. This may be tracked via a DM task counter in the active DM task counters 536 for each of the active calls. In some examples, calls may finish in a different order than they were received.

The tasks for a particular call may be tracked and handled by the active DM task handler 514. The active DM task handler component 514 monitors all active data mover tasks and determines when various phases should begin for each of the active tasks and determines when those tasks are complete. For example, the active DM task handler component 514 may determine when reads should be issued for read phases that begin with fetches to address or index lists, determine when the write phase begins for each DM task, and detects when a DM task is complete. The DM task read issue component 542 may be used to issue read tasks, including reading address lists or other indexes stored in memory by issuing a read to one or more AXI slices. The DM task write issue component 540 may issue one or more write tasks to one or more AXI slices. Both the read and write tasks may utilize coordinated read and/or write phases. The active write counters component 544 and active read counters component 546 allow the active DM task handler component 514 to track the progress of the tasks and report back to the active call handler component 532 when tasks are completed.

As previously noted, the AXI slice components 520-A, 520-B, 520-C, and 520-D convert tasks to AXI read/write commands. In some examples, various slice-to-slice optimizations may be performed. For example, the system may utilize write combining where a portion of memory written in a previous DM task may be passed to a subsequent slice so that a write can be merged with a portion of memory for the next DM task. This may reduce the number of AXI writes that are needed for certain tasks. For example, writes done to the last 1-15 bytes of a DM task can be passed to the subsequent slice so that the write can be merged with the first 1-15 Bytes of the next DM task to reduce the number of AXI writes which are needed. For large calls the last slice in the data mover task group passes a partial write to the next data mover task group. To enable more write combining, each slice may include one or more write data exporting buffers. Another optimization may be read data borrowing where one DM task can get data from another slice's reads. For example, slice 0 borrows fetch data from slice 1; slice 1 borrows fetch data from slice 2; slice 2 borrows from slice 3. Slice 3 will borrow from slice 0, but it will borrow from the next data mover task group.

In some examples, the slice conductor component 518 coordinates reads and writes between the AXI slices to optimize memory usage as well as enabling the write combining, read data borrowing, and address fetch data borrowing. The slice conductor component 518 detects when all slices are ready to start coordinated reads or coordinated writes and initiates these coordinated reads and writes.

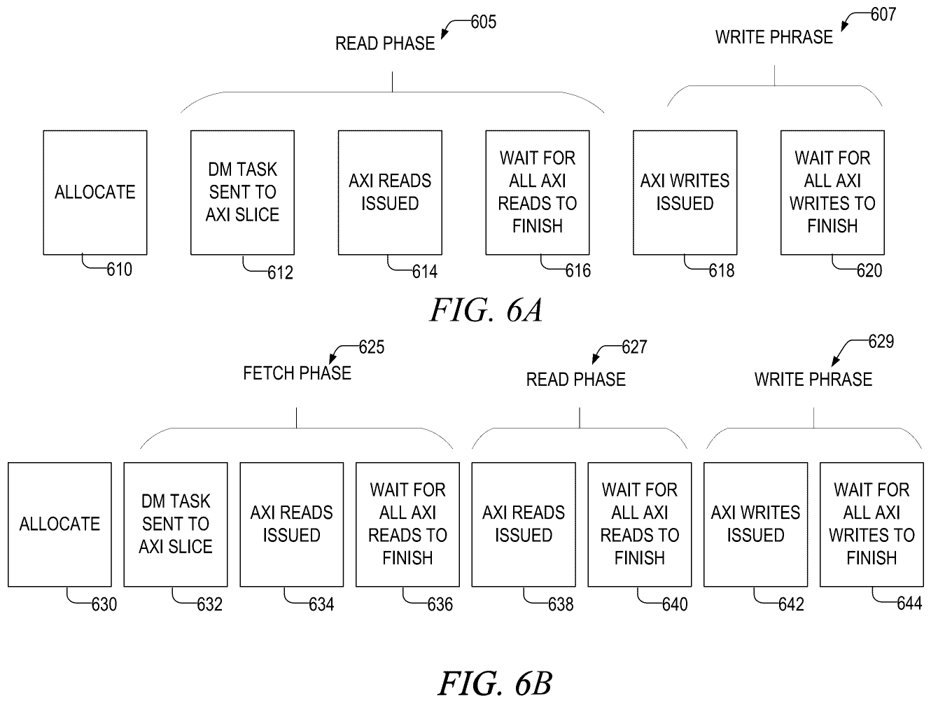

As noted, the FGDM breaks calls into data mover tasks (DMTs) where each data mover task is responsible for reading and writing to memory. FIG. 6A illustrates the phases of a DMT that are launched from copy, scatter-stride, or gather-stride calls according to some examples of the present disclosure. An allocation phase 610 is first, followed by a read phase 605 and a write phase 607. The read phase first sends the DM task to the AXI slice 612. The AXI slice uses the DMTs to issue AXI reads at 614. The slice waits for all AXI reads to finish at 616. After the read phase 605 is complete, the write phase 607 starts. The write phase starts at 618 by issuing AXI writes and then waiting for all AXI writes to finish at 620.

FIG. 6B illustrates the phases DMTs generated from scatter-address, scatter-index, gather-address, and gather-index calls according to some examples of the present disclosure. An allocation phase 630 is followed by a fetch phase 625, a read phase 627, and a write phase 629. The fetch phase 625 fetches the list of addresses or offsets (depending on the addressing mode) and starts by sending the DM task to the AXI slice at 632. At 634, the AXI reads are issued to read the address list, offset list, or the like from memory. At 636, the AXI slice waits for all AXI reads to finish. After the fetch phase 625 is complete, the read phase begins at 627. AXI reads are issued at 638, the system waits for all AXI reads to finish at 640 and once all reads have finished, the DM Task moves to the write phase 629. The write phase starts with issuing write commands at 642. After the write commands are issued, the system waits for all AXI writes to finish at 644.

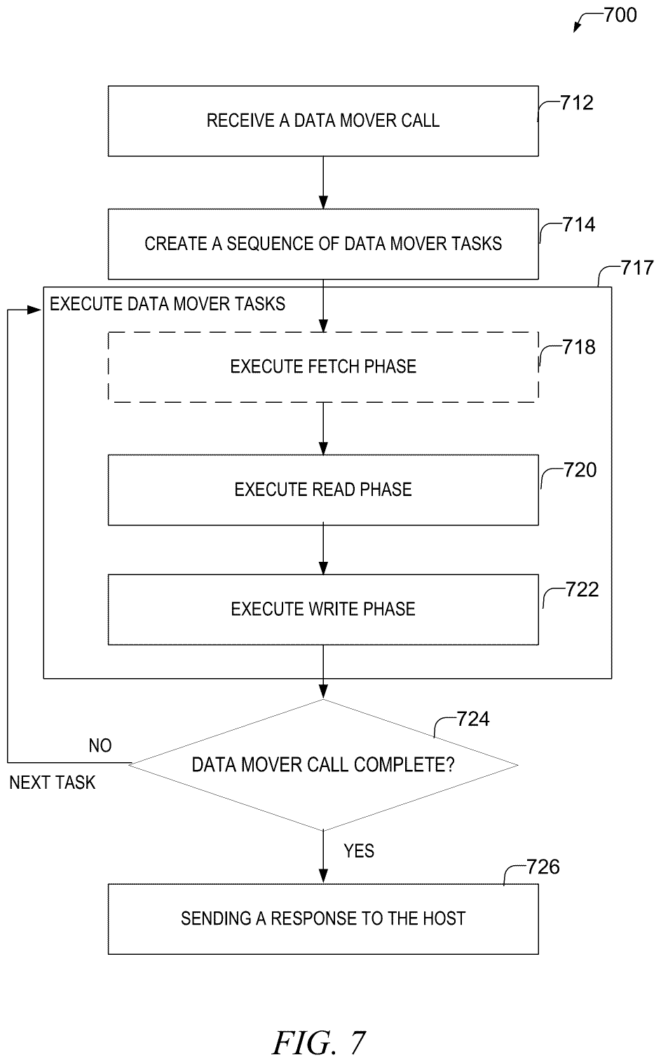

FIG. 7 illustrates a flowchart of a method 700 of processing a call in a fine-grained data mover according to some examples of the present disclosure. At operation 712, the FGDM receives a data mover call. The call may be received via a network-on-chip interface. In some examples, the data mover call may be received from a host system. In some examples, the data mover call may comprise a copy command to move a specified number of bytes from one virtual address to another virtual address. In other examples, the data mover call may comprise a gather command that moves data from a number of non-contiguous source locations into contiguously addressed memory. In yet other examples, the data mover call may comprise a scatter command which moves data from a contiguously addressed buffer into a number of non-contiguous memory locations. In yet additional examples, the data mover call may comprise a set command which writes a data pattern into a number of destination elements. In some examples, the data mover call specifies source and/or destination locations. The data mover call may specify the source and/or destination location by providing an address where the source and/or destination locations are stored.

At operation 714, the FGDM creates a set of data mover tasks based upon the data mover call. For example, the FGDM may identify the set of data mover tasks using a mapping table or algorithm and by reading parameters from the call itself (e.g., memory addresses). In some examples, each data mover task includes a read phase or a write phase. Some data mover tasks, depending on the format of the call, may include a fetch phase to fetch address data from the memory. The task read phase reads values from memory, and the write phase writes values to memory.

At operation 717, the FGDM executes one or more data mover tasks in the set. In some examples, operation 717 includes executing multiple data mover tasks from a same call concurrently. In some examples, one or more data mover tasks from multiple different calls may be executed concurrently. Each data mover task may be executed by first executing any fetch phase at operation 718. As noted, the fetch phase retrieves the addresses or offsets (either source and/or destination) from memory. The fetch phase starts by sending the task to the AXI slice which issues AXI read commands. The phase then waits for all the AXI reads to finish before completing. The next phase is the read phase 720 which starts by sending the task to the AXI slice which issues AXI read commands. The phase then waits for all the AXI reads to finish before completing. Finally, the write phase starts after completion of both the fetch and read phases at operation 722. The write phase starts by sending the task to the AXI slice which issues AXI write commands. The phase then waits for all the AXI write commands to finish before completing.

At operation 724, a determination is made for a particular call whether all the data mover tasks are complete for that call. For example, the system may set a counter value to a number of tasks that were created for a particular call and decrement the counter each time a task completes. Once the counter is zero, the call is completed. If additional tasks are to be completed, those tasks are executed at operation 717. Once all tasks are completed, then at operation 726, the FGDM sends a response to the data mover call to the host.

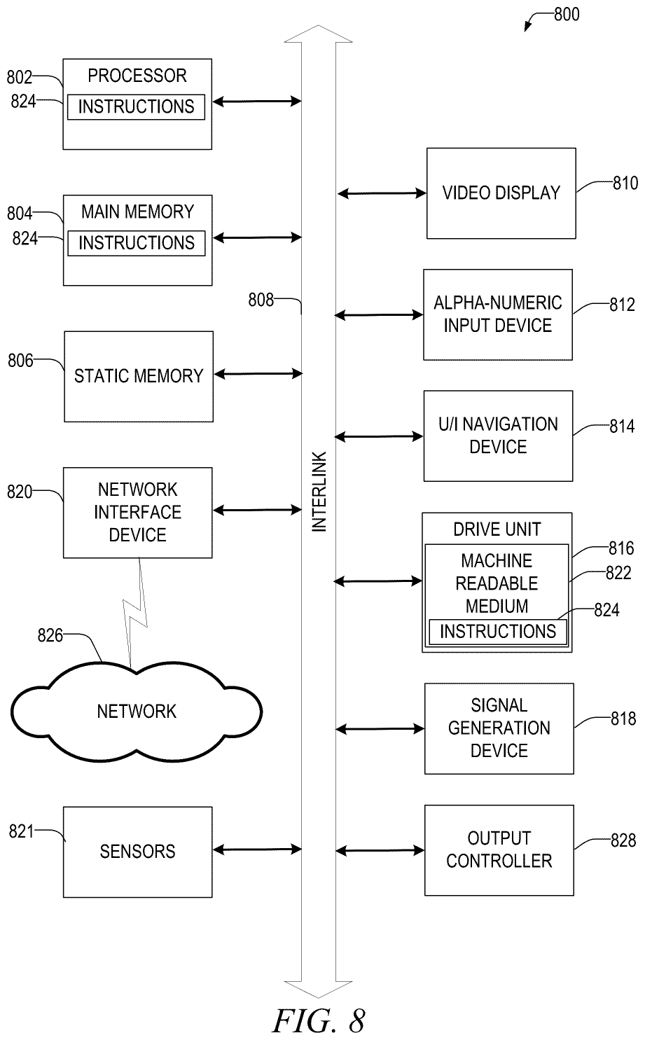

FIG. 8 illustrates a block diagram of an example machine 800 upon which any one or more of the techniques (e.g., methodologies) discussed herein may be performed. In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be in the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. Machine 800 may be, or be configured to be, a host system, a CXL fabric, a memory controller, a FGDM, a memory device, or the like. Machine 800 may be arranged as a distributed memory system. The FGDM may be configured to be, or may include, the components of FIGS. 1A, 1B, 2, 3, 4, 5; to implement the phases of FIGS. 6A AND 6B, and the methods of FIG. 7.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which components are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 800 may include one or more hardware processors, such as processor 802. Processor 802 may be a central processing unit (CPU), a graphics processing unit (GPU), a hardware processor core, or any combination thereof. Machine 800 may include a main memory 804 and a static memory 806, some or all of which may communicate with each other via an interlink (e.g., bus) 808. Examples of main memory 804 may include Synchronous Dynamic Random-Access Memory (SDRAM), such as Double Data Rate memory, such as DDR4 or DDR5. Interlink 808 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 800 may further include a display unit 810, an alphanumeric input device 812 (e.g., a keyboard), and a user interface (UI) navigation device 814 (e.g., a mouse). In an example, the display unit 810, input device 812 and UI navigation device 814 may be a touch screen display. The machine 800 may additionally include a storage device (e.g., drive unit) 816, a signal generation device 818 (e.g., a speaker), a network interface device 820, and one or more sensors 821, such as a global positioning system (GPS) sensor, compass, accelerometer, or other sensor. The machine 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 may constitute machine readable media.

While the machine readable medium 822 is illustrated as a single medium, the term “machine readable medium” may include a single medium or multiple media (e.g., a centralized or distributed database, and/or associated caches and servers) configured to store the one or more instructions 824.

The term “machine readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 824 may further be transmitted or received over a communications network 826 using a transmission medium via the network interface device 820. The Machine 800 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. In some examples, the network interface device 820 may wirelessly communicate using Multiple User MIMO techniques.

### Other Notes and Examples

Example 1 is a method for offloading memory access workloads from a host system in a distributed memory architecture, the method comprising: at a processor on a memory controller: receiving a data mover call from a host, the data mover call comprising a copy command, gather command, scatter command, or set command, the data mover call specifying one or more source and one or more destination memory locations; creating a set of data mover tasks based upon the data mover call, the data mover tasks created based upon a specified mapping between data mover calls and data mover tasks, each data mover task including a read phase and a write phase; executing each data mover task in the set by executing each phase of each particular task of the set of data mover tasks by issuing memory access commands corresponding to the phase of the particular one of the set of data mover tasks; concurrently executing a plurality of memory commands of the set of data mover tasks on a plurality of memory interface slices, the plurality of memory commands targeting memory locations specified in the data mover call; determining that all the data mover tasks for the data mover call have completed; and sending a response to the data mover call to the host.

In Example 2, the subject matter of Example 1 includes, wherein the data mover call comprises a first memory location, a stride amount, an element size, and a number of elements, and wherein the set of data mover tasks access a plurality of memory locations indicated by the number of elements and starting with the first memory location and incrementing by the stride amount.

In Example 3, the subject matter of Examples 1-2 includes, wherein the data mover call comprises a location of a list of addresses and wherein one of the set of data mover tasks comprises fetching the list of addresses.

In Example 4, the subject matter of Examples 1-3 includes, wherein the data mover call comprises a first location, and second location storing a list of offsets and wherein one of the set of data mover tasks comprises fetching the list of offsets.

In Example 5, the subject matter of Examples 1-4 includes, wherein the data mover tasks comprise a task to read from one contiguous memory location and write data into one to many contiguous memory locations, a task to read from one to many memory locations and write data into one contiguous memory location, and a task to write into one to many memory locations.

In Example 6, the subject matter of Examples 1-5 includes, wherein the memory interface slices are commanded to start the memory commands at a same time.

In Example 7, the subject matter of Examples 1-6 includes, concurrently executing, by the memory controller, a second data mover call from the host at a same time as executing the first data mover call.

Example 8 is a memory controller device for offloading memory access workloads from a host system in a distributed memory architecture, the memory controller device comprising: a processor configured to perform operations comprising: receiving a data mover call from a host, the data mover call comprising a copy command, gather command, scatter command, or set command, the data mover call specifying one or more source and one or more destination memory locations; creating a set of data mover tasks based upon the data mover call, the data mover tasks created based upon a specified mapping between data mover calls and data mover tasks, each data mover task including a read phase and a write phase; executing each data mover task in the set by executing each phase of each particular task of the set of data mover tasks by issuing memory access commands corresponding to the phase of the particular one of the set of data mover tasks; concurrently executing a plurality of memory commands of the set of data mover tasks on a plurality of memory interface slices, the plurality of memory commands targeting memory locations specified in the data mover call; determining that all the data mover tasks for the data mover call have completed; and sending a response to the data mover call to the host.

In Example 9, the subject matter of Example 8 includes, wherein the data mover call comprises a first memory location, a stride amount, an element size, and a number of elements, and wherein the set of data mover tasks access a plurality of memory locations indicated by the number of elements and starting with the first memory location and incrementing by the stride amount.

In Example 10, the subject matter of Examples 8-9 includes, wherein the data mover call comprises a location of a list of addresses and wherein one of the set of data mover tasks comprises fetching the list of addresses.

In Example 11, the subject matter of Examples 8-10 includes, wherein the data mover call comprises a first location, and second location storing a list of offsets and wherein one of the set of data mover tasks comprises fetching the list of offsets.

In Example 12, the subject matter of Examples 8-11 includes, wherein the data mover tasks comprise a task to read from one contiguous memory location and write data into one to many contiguous memory locations, a task to read from one to many memory locations and write data into one contiguous memory location, and a task to write into one to many memory locations.

In Example 13, the subject matter of Examples 8-12 includes, wherein the operations further comprise classifying the data mover call into a selected category of one of a plurality of predetermined categories; and wherein creating the set of data mover tasks based upon the data mover call comprises utilizing the selected category to determine a launch rate, a slice interleaving policy, or an allocation policy.

In Example 14, the subject matter of Examples 8-13 includes, wherein a data mover task includes a fetch phase.

Example 15 is a non-transitory machine-readable medium, storing instructions for offloading memory access workloads from a host system in a distributed memory architecture, the instructions, when executed by a processor of a memory controller, cause the memory controller to perform operations comprising: receiving a data mover call from a host, the data mover call comprising a copy command, gather command, scatter command, or set command, the data mover call specifying one or more source and one or more destination memory locations; creating a set of data mover tasks based upon the data mover call, the data mover tasks created based upon a specified mapping between data mover calls and data mover tasks, each data mover task including a read phase and a write phase; executing each data mover task in the set by executing each phase of each particular task of the set of data mover tasks by issuing memory access commands corresponding to the phase of the particular one of the set of data mover tasks; concurrently executing a plurality of memory commands of the set of data mover tasks on a plurality of memory interface slices, the plurality of memory commands targeting memory locations specified in the data mover call; determining that all the data mover tasks for the data mover call have completed; and sending a response to the data mover call to the host.

In Example 16, the subject matter of Example 15 includes, wherein the data mover call comprises a first memory location, a stride amount, an element size, and a number of elements, and wherein the set of data mover tasks access a plurality of memory locations indicated by the number of elements and starting with the first memory location and incrementing by the stride amount.

In Example 17, the subject matter of Examples 15-16 includes, wherein the data mover call comprises a location of a list of addresses and wherein one of the set of data mover tasks comprises fetching the list of addresses.

In Example 18, the subject matter of Examples 15-17 includes, wherein the data mover call comprises a first location, and second location storing a list of offsets and wherein one of the set of data mover tasks comprises fetching the list of offsets.

In Example 19, the subject matter of Examples 15-18 includes, wherein the data mover tasks comprise a task to read from one contiguous memory location and write data into one to many contiguous memory locations, a task to read from one to many memory locations and write data into one contiguous memory location, and a task to write into one to many memory locations.

In Example 20, the subject matter of Examples 15-19 includes, wherein the operations further comprise: classifying the data mover call into a selected category of one of a plurality of predetermined categories; and wherein creating the set of data mover tasks based upon the data mover call comprises utilizing the selected category to determine a launch rate, a slice interleaving policy, or an allocation policy.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A method for offloading memory access workloads from a host system in a distributed memory architecture, the method comprising:
at a processor on a memory controller:
receiving a data mover call, the data mover call comprising a request to copy values, a request to gather values, a request to scatter values, or a request to set values, the data mover call specifying one or more source and one or more destination memory locations;
creating a set of data mover tasks based upon the data mover call, the data mover tasks created based upon a specified mapping between data mover calls and data mover tasks, each data mover task including a read phase and a write phase;
executing each data mover task in the set by executing each phase of each particular task of the set of data mover tasks by issuing memory access commands corresponding to the phase of the particular one of the set of data mover tasks;
concurrently executing a plurality of memory commands of the set of data mover tasks on a plurality of memory interface slices, the plurality of memory commands targeting memory locations specified in the data mover call;
determining that all the data mover tasks for the data mover call have completed; and
sending a response to the data mover call to the host.

2. The method of claim 1, wherein the data mover call comprises a first memory location, a stride amount, an element size, and a number of elements, and wherein the set of data mover tasks access a plurality of memory locations indicated by the number of elements and starting with the first memory location and incrementing by the stride amount.

3. The method of claim 1, wherein the data mover call comprises a location of a list of addresses and wherein one of the set of data mover tasks comprises fetching the list of addresses.

4. The method of claim 1, wherein the data mover call comprises a first location, and second location storing a list of offsets and wherein one of the set of data mover tasks comprises fetching the list of offsets.

5. The method of claim 1, wherein the data mover tasks comprise a task to read from one contiguous memory location and write data into one to many contiguous memory locations, a task to read from one to many memory locations and write data into one contiguous memory location, and a task to write into one to many memory locations.

6. The method of claim 1, wherein the memory interface slices are commanded to start the memory commands at a same time.

7. The method of claim 1, further comprising:
concurrently executing, by the memory controller, a second data mover call from the host at a same time as executing the first data mover call.

8. A memory controller device for offloading memory access workloads from a host system in a distributed memory architecture, the memory controller device comprising:
a processor configured to perform operations comprising:
receiving a data mover call, the data mover call comprising a request to copy values, a request to gather values, a request to scatter values, or a request to set values, the data mover call specifying one or more source and one or more destination memory locations;
creating a set of data mover tasks based upon the data mover call, the data mover tasks created based upon a specified mapping between data mover calls and data mover tasks, each data mover task including a read phase and a write phase;
executing each data mover task in the set by executing each phase of each particular task of the set of data mover tasks by issuing memory access commands corresponding to the phase of the particular one of the set of data mover tasks;
concurrently executing a plurality of memory commands of the set of data mover tasks on a plurality of memory interface slices, the plurality of memory commands targeting memory locations specified in the data mover call;
determining that all the data mover tasks for the data mover call have completed; and
sending a response to the data mover call to the host.

9. The memory controller device of claim 8, wherein the data mover call comprises a first memory location, a stride amount, an element size, and a number of elements, and wherein the set of data mover tasks access a plurality of memory locations indicated by the number of elements and starting with the first memory location and incrementing by the stride amount.

10. The memory controller device of claim 8, wherein the data mover call comprises a location of a list of addresses and wherein one of the set of data mover tasks comprises fetching the list of addresses.

11. The memory controller device of claim 8, wherein the data mover call comprises a first location, and second location storing a list of offsets and wherein one of the set of data mover tasks comprises fetching the list of offsets.

12. The memory controller device of claim 8, wherein the data mover tasks comprise a task to read from one contiguous memory location and write data into one to many contiguous memory locations, a task to read from one to many memory locations and write data into one contiguous memory location, and a task to write into one to many memory locations.

13. The memory controller device of claim 8, wherein the operations further comprise classifying the data mover call into a selected category of one of a plurality of predetermined categories; and
wherein creating the set of data mover tasks based upon the data mover call comprises utilizing the selected category to determine a launch rate, a slice interleaving policy, or an allocation policy.

14. The memory controller device of claim 8, wherein a data mover task includes a fetch phase.

15. A non-transitory machine-readable medium, storing instructions for offloading memory access workloads from a host system in a distributed memory architecture, the instructions, when executed by a processor of a memory controller, cause the memory controller to perform operations comprising:
receiving a data mover call, the data mover call comprising a request to copy values, a request to gather values, a request to scatter values, or a request to set values, the data mover call specifying one or more source and one or more destination memory locations;
creating a set of data mover tasks based upon the data mover call, the data mover tasks created based upon a specified mapping between data mover calls and data mover tasks, each data mover task including a read phase and a write phase;
executing each data mover task in the set by executing each phase of each particular task of the set of data mover tasks by issuing memory access commands corresponding to the phase of the particular one of the set of data mover tasks;
concurrently executing a plurality of memory commands of the set of data mover tasks on a plurality of memory interface slices, the plurality of memory commands targeting memory locations specified in the data mover call;
determining that all the data mover tasks for the data mover call have completed; and
sending a response to the data mover call to the host.

16. The non-transitory machine-readable medium of claim 15, wherein the data mover call comprises a first memory location, a stride amount, an element size, and a number of elements, and wherein the set of data mover tasks access a plurality of memory locations indicated by the number of elements and starting with the first memory location and incrementing by the stride amount.

17. The non-transitory machine-readable medium of claim 15, wherein the data mover call comprises a location of a list of addresses and wherein one of the set of data mover tasks comprises fetching the list of addresses.

18. The non-transitory machine-readable medium of claim 15, wherein the data mover call comprises a first location, and second location storing a list of offsets and wherein one of the set of data mover tasks comprises fetching the list of offsets.

19. The non-transitory machine-readable medium of claim 15, wherein the data mover tasks comprise a task to read from one contiguous memory location and write data into one to many contiguous memory locations, a task to read from one to many memory locations and write data into one contiguous memory location, and a task to write into one to many memory locations.

20. The non-transitory machine-readable medium of claim 15, wherein the operations further comprise:
classifying the data mover call into a selected category of one of a plurality of predetermined categories; and
wherein creating the set of data mover tasks based upon the data mover call comprises utilizing the selected category to determine a launch rate, a slice interleaving policy, or an allocation policy.
